(19) United States
(12) Patent Application Publication
(10) Pub. No.: US 2025/0238943 A1
(43) Pub. Date: Jul. 24, 2025

(54) IMAGING DEVICE, METHOD OF ESTIMATING SUBJECT DEPTH, AND PROGRAM

(71) Applicant: Japan Display Inc., Tokyo (JP)

(72) Inventors: Hirondo NAKATOGAWA, Tokyo (JP); Yoshiro AOKI, Tokyo (JP); Hitoshi TANAKA, Tokyo (JP)

(21) Appl. No.: 19/175,146

(22) Filed: Apr. 10, 2025

Related U.S. Application Data
(63) Continuation of application No. PCT/JP2023/030341, filed on Aug. 23, 2023.

(30) Foreign Application Priority Data
Oct. 13, 2022 (JP) 2022-164826

(51) Int. Cl. G06T 7/571; G01C 3/08; G06V 20/58

(52) U.S. Cl. CPC G06T 7/571; G01C 3/08; G06V 20/58; G06T 2207/30252; G06V 2201/08

(57) ABSTRACT

Practicality is improved in estimation of a subject depth by coded imaging. An arithmetic control unit coded images a subject using a first imaging system having a first angle of view to obtain a first imaged image, detects a specific object that is included in the subject and is positioned at a distance from the first imaging system equal to or greater than a threshold based on the first imaged image, coded images the detected specific object using a second imaging system having a second angle of view that is narrower than the first angle of view to obtain a second imaged image, and decodes the first imaged image and the second imaged image to obtain depth information of the subject and depth information of the specific object.

### CROSS REFERENCE TO RELATED APPLICATIONS

The present application is a continuation of International Application No. PCT/JP2023/030341 filed on Aug. 23, 2023 and claims priority to Japanese Patent Application No. 2022-164826 filed on Oct. 13, 2022, the disclosure of which is incorporated herein by reference.

### BACKGROUND

The present disclosure relates to an imaging device, a method of estimating a subject depth, and a program.

In the field of coded imaging, a technique called Depth From Defocus (DFD) is known. The DFD technique is a technique that estimates the distance from an optical system of an imaging device to a subject, that is, the deepness or depth of the subject, based on the degree of edge blurring that appears in an image obtained by imaging.

The DFD technique is described, for example, in International Publication No. 2011-158508 (Patent Document 1) or “Coded Aperture Pairs for Depth from Defocus and Defocus Deblurring” C. Zhou, S. Lin and S. K. Nayar, International Journal of Computer Vision, Vol. 93, No. 1, pp. 53, May. 2011. (Non-Patent Document 1). In the DFD technique described in Non-Patent Document 1, a mask is prepared in which a geometric pattern of an apertures through which light passes is known in advance. Next, the prepared mask is disposed in the light entry region of the optical system, and coded imaging is performed to image the subject. Next, the imaged image obtained by the coded imaging is subjected to decoding processing based on a point spread function specific to the mask used, and the depth of the subject is estimated. The point spread function is generally referred to as PSF, and is also referred to as blur function, blur spread function, a point image distribution function, etc.

### SUMMARY

The DED technique is still in the process of development and has room for improvement in terms of practicality. Due to the above circumstances, a more practical DFD technique is desired.

Among the disclosures disclosed in the present application, a representative disclosure will be outlined as follows.

According to one representative embodiment of the present disclosure is an imaging device including a first imaging system having a first angle of view, a second imaging system having a second angle of view that is narrower than the first angle of view, and an arithmetic control unit connected to the first imaging system and the second imaging system, wherein the arithmetic control unit performs first imaging processing to coded image a subject using the first imaging system to obtain a first imaged image, detection processing to detect a specific object that is included in the subject and is positioned at a distance from the first imaging system equal to or greater than a threshold based on the obtained first imaged image, second imaging processing to coded image the detected specific object using the second imaging system to obtain a second imaged image, first decoding processing to decode the first imaged image to obtain first depth information representing a depth of an object at each position of the subject, and second decoding processing to decode the second imaged image to obtain second depth information representing a depth of the specific object.

According to one representative embodiment of the present disclosure is an imaging device including a first imaging system having a first angle of view, a second imaging system having a second angle of view that is narrower than the first angle of view, and an arithmetic control unit connected to the first imaging system and the second imaging system, wherein the arithmetic control unit performs first imaging processing to coded image a subject using the first imaging system to obtain a first imaged image, first decoding processing to decode the first imaged image to obtain a first decoded image representing the subject and first depth information representing a depth of an object at each position of the subject, detection processing to detect a specific object that is included in the subject and is positioned at a distance from the first imaging system equal to or greater than a threshold based on the first decoded image, second imaging processing to coded image the detected specific object using the second imaging system to obtain a second imaged image, and second decoding processing to decode the second imaged image to obtain second depth information representing a depth of the specific.

According to one representative embodiment of the present disclosure is a method of estimating a subject depth, including coded imaging a subject using a first imaging system having a first angle of view to obtain a first imaged image, detecting a specific object that is included in the subject and is positioned at a distance from the first imaging system equal to or greater than a threshold based on the first imaged image, coded imaging the detected specific object using a second imaging system having a second angle of view that is narrower than the first angle of view to obtain a second imaged image, and decoding the first imaged image and the second imaged image to obtain depth information of the subject and depth information of the specific object.

According to one representative embodiment of the present disclosure is a method of estimating a subject depth, including coded imaging a subject using a first imaging system having a first angle of view to obtain a first imaged image, decoding the first imaged image to obtain a first decoded image representing the subject and depth information of the subject, detecting a specific object that is included in the subject and is positioned at a distance from the first imaging system equal to or greater than a threshold based on the first decoded image, coded imaging the detected specific object using a second imaging system having a second angle of view that is narrower than the first angle of view to obtain a second imaged image, and decoding the second imaged image to obtain depth information of the specific object.

According to one representative embodiment of the present disclosure is a program causing a computer to execute processing to coded image a subject using a first imaging system having a first angle of view to obtain a first imaged image, processing to detect a specific object that is included in the subject and is positioned at a distance from the first imaging system equal to or greater than a threshold based on the first imaged image, processing to coded image the detected specific object using a second imaging system having a second angle of view that is narrower than the first angle of view to obtain a second imaged image, and processing to decode the first imaged image and the second imaged image to obtain depth information of the subject and depth information of the specific object.

According to one representative embodiment of the present disclosure is a program causing a computer to execute, processing to coded image a subject using a first imaging system having a first angle of view to obtain a first imaged image, processing to decode the first imaged image to obtain a first decoded image representing the subject and depth information of the subject, processing to detect a specific object that is included in the subject and is positioned at a distance from the first imaging system equal to or greater than a threshold based on the first decoded image, processing to coded image the detected specific object using a second imaging system having a second angle of view that is narrower than the first angle of view to obtain a second imaged image, and processing to decode the second imaged image to obtain depth information of the specific object.

### BRIEF DESCRIPTION OF THE DRAWINGS

FIG. 1 is a diagram illustrating an installation example of an imaging device according to a first embodiment.

FIG. 2 is a diagram illustrating a configuration example of the imaging device.

FIG. 3 is a diagram illustrating a configuration example of a standard imaging system.

FIG. 4 is a diagram illustrating a configuration example of a telephoto imaging system.

FIG. 5 is a diagram illustrating a configuration example of an arithmetic control unit.

FIG. 6 is a schematic diagram illustrating various processing performed by the arithmetic control unit.

FIG. 7 is a diagram illustrating how a depth map is generated.

FIG. 8 is a flowchart illustrating an example of processing in the imaging device according to the first embodiment.

FIG. 9 is a flowchart illustrating a modification of processing in the imaging device according to the first embodiment.

FIG. 10 is a flowchart illustrating the modification of processing in the imaging device.

FIG. 11 is an example of a liquid crystal optical shutter implementing a plurality of masks.

FIG. 12 is a diagram illustrating an example of how a subject in front of an automobile is imaged using the imaging system mounted on the automobile.

FIG. 13 is a diagram illustrating an example of an imaged image of the subject imaged at night by the imaging system mounted on the automobile.

FIG. 14A is a diagram illustrating the spread of blur in an image when a relatively close object to the optical system among distant objects is imaged by an imaging system of wide-angle type.

FIG. 14B is a diagram illustrating the spread of blur in an image when a distant object is imaged by the imaging system of wide-angle type.

FIG. 15A is a diagram illustrating the spread of blur in an image when a close object is imaged by an imaging system of telephoto type.

FIG. 15B is a diagram illustrating the spread of blur in an image when a distant object is imaged by the imaging system of telephoto type.

### DETAILED DESCRIPTION

Before describing each embodiment of the present disclosure, the basic content of the DFD technique and problems discovered by the present inventors will be described.

The state of blur of a subject in an imaged image typically depends on a point spread function, which is determined by an optical system of an imaging device, the shape of a light entry region of the optical system, and the like. When a mask that partially shields light is disposed in the light entry region of the optical system, the point spread function is determined for each mask. Imaging a subject with an imaging device in which a mask is disposed is referred to as coded imaging. When the object is coded imaged, a blurred image is obtained based on the point spread function specific to the mask used.

When the blurred image is subjected to decoding processing that involves deconvolution based on the point spread function specific to the mask used, a decoded image with reduced blur and depth information of the object corresponding to each position in the decoded image are obtained.

Meanwhile, the present inventors have examined the DFD technique using coded imaging with a mask and have found that estimation accuracy of depth of a distant object appearing in an imaged image is low. In particular, when imaging at night or in dark environments such as inside a tunnel, the contrast in the imaged image does not appear clearly, further reducing the estimation accuracy of depth of the distant object.

Here, a situation in which the estimation accuracy of a depth of a distant object distant from the imaging system lowers will be described using a specific example.

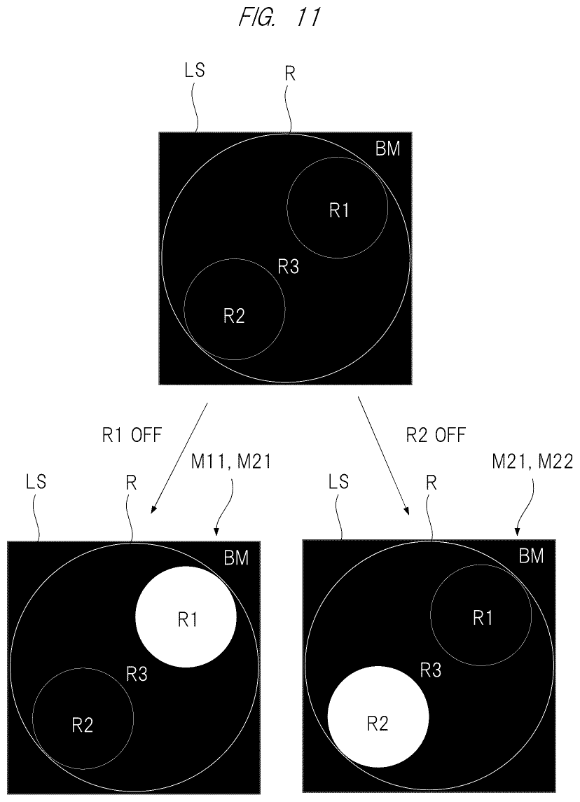

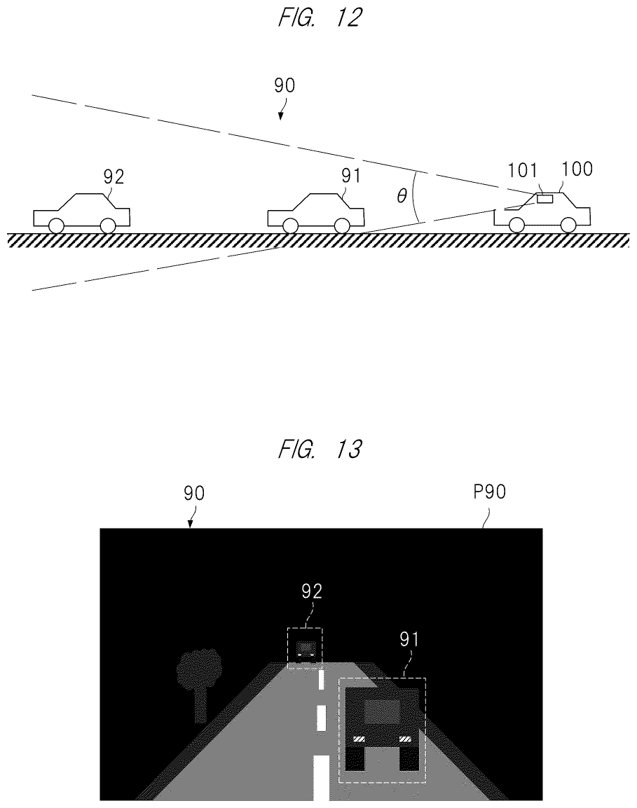

FIG. 12 is a diagram illustrating an example of how a subject in front of an automobile is imaged using an imaging system mounted on the automobile. FIG. 13 is a diagram illustrating an example of an imaged image of the subject imaged at night by the imaging system mounted on the automobile.

For example, as illustrated in FIG. 12, a subject 90 in front of an automobile 100 is imaged by an imaging system 101 mounted on the automobile 100. The subject 90 includes a front car 91 that is relatively close to the automobile 100 and a front car 92 that is relatively distant from the automobile 100. When the subject 90 in front is imaged by the imaging system 101 at night, for example, an imaged image as illustrated in FIG. 13 is obtained.

In general, when imaging the subject 90 to grasp the surroundings of the automobile 100, a standard optical system with a wide angle of view θ, such as a wide-angle lens, is used as the optical system of the imaging system 101 as illustrated in FIG. 12. In this case, as illustrated in FIG. 13, the proportion of the area of the image representing the front car 92, which is a distant object more distant than the front car 91 is, which is an object relatively close to the automobile 100, in the entire image area of an imaged image P90 representing the subject 90 is relatively small, and the number of pixels in the image representing the distant object, i.e., the front car 92, is smaller.

Furthermore, when imaging in a dark environment, even if light is irradiated onto the subject 90 using a lighting device or the like, the amount of light reflected from the distant object is small, making it difficult to recognize the degree of blurring in the image of the distant object. For example, when imaging the subject 90 in front of the automobile 100 traveling at night, a distant front car 92 may blend into the darkness of the surroundings, with only the taillights of the front car 92 being faintly discernible. That is, it is not uncommon that the edges in an image representing the distant front car 92 are less likely to emerge in the imaged image.

It is considered that these aforementioned circumstances reduce the estimation accuracy of a depth of a distant object in coded imaging.

In view of the above circumstances, in a DFD method in which a mask is used to image a subject and estimate the depth of the subject, a technique is desired that can estimate the depth of a distant object that appears in the imaged image with higher accuracy.

In view of the above circumstances, the present inventors conducted the following examination. The present inventors focused on the fact that, when performing coded imaging an object with an imaging system of telephoto type, compared to coded imaging an object using an imaging system of wide-angle type, a difference in the depth of the object is more likely to be reflected in a scope of the spread of the blurred image of the object appearing in the imaged image, that is, in the number of pixels. The inventors then discovered that when the same object is coded imaged using the imaging system of wide-angle type and the imaging system of telephoto type, the accuracy of depth estimation of the object using the imaging system of telephoto type is higher than the accuracy of depth estimation of the object using the imaging system of wide-angle type.

### Relationship between Angle of View of Imaging System and Estimation Accuracy of Depth of Object

Here, the relationship between an angle of view of an imaging system and the estimation accuracy of a depth of an object described so that the characteristic that estimation accuracy of the depth of the object using the imaging system of telephoto type is higher than estimation accuracy of the depth of the object using the imaging system of wide-angle type can be understood.

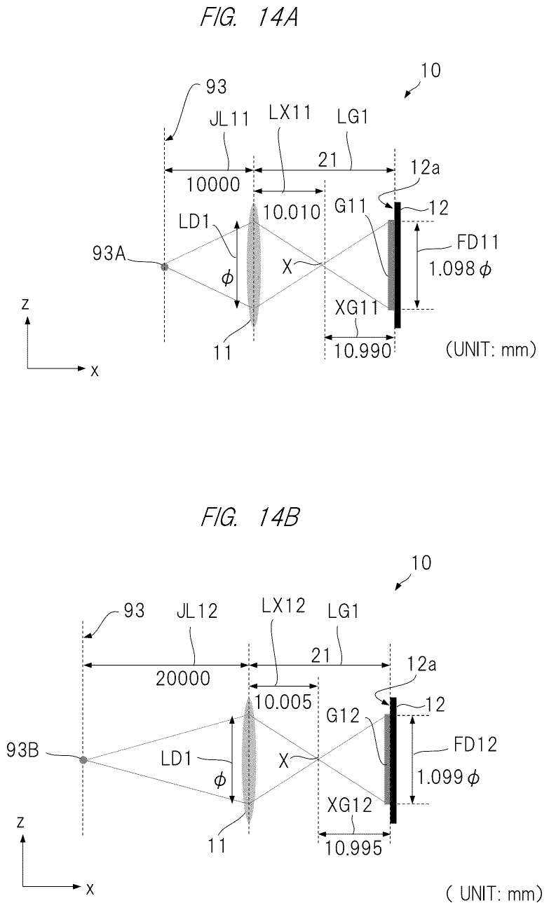

First, the estimation accuracy of the depth of the object using the imaging system with a wide angle of view will be described. FIG. 14A is a diagram illustrating the spread of blur in an image when a relatively close object to the optical system among distant objects is imaged by the imaging system of wide-angle type. FIG. 14B is a diagram illustrating the spread of blur in an image when a distant object is imaged by the imaging system of wide-angle type. In FIGS. 14A and 14B, a direction of the main axis of the optical system is an x direction, and a direction perpendicular to the x direction is a y direction.

As illustrated in FIGS. 14A and 14B, a standard imaging system 10, which is an imaging system of wide-angle type, includes a standard optical system 11, which is an optical system of wide-angle type, and an imaging element 12, both of which are arranged with a gap in the x direction. Here, assuming that, in the standard optical system 11, the focal length f=10 mm and the focusing distance=19.1 mm, when the distance from the standard optical system 11 to a light receiving surface 12a of the imaging element 12 is represented as LG1, then the lens formula gives: 1/LG1+1/19.1˜1/10, and thus the distance LG1=21 mm. Also, when the diameter of the standard optical system 11 is represented as LD1, the optical system diameter LD1=φ.

First, as illustrated in FIG. 14A, it is assumed that the distance from the standard optical system 11 to a point 93A on the surface of a subject 93, that is, the depth JL11 of the subject 93=10000 mm. When the distance from the standard optical system 11 to the focal point X is represented as LX11, the lens formula gives: 1/LX11+1/10000˜1/10, and thus the distance LX11=10.010. When the distance from the focal point X to the light receiving surface 12a is represented as XG11, distance XG11=distance LG1−distance LX11, and therefore the distance XG11=21−10.010=10.990 mm.

When the diameter of a blurred image G11 of the point 93A appearing on the light receiving surface 12a is represented as the blur diameter FD11, blur diameter FD11=(distance XG11/distance LX11)×optical system diameter LD1, and thus the blur diameter FD11=(10.990/10.010)×φ=1.098φ.

Next, as illustrated in FIG. 14B, it is assumed that the distance from the standard optical system 11 to a point 93B on the surface of the subject 93, that is, the depth JL12 of the subject 93=20000 mm. When the distance from the standard optical system 11 to the focal point X is represented as LX12, the lens formula gives: 1/LX12+1/20000˜1/10, and this the distance LX12=10.005. When the distance from the focal point X to the light receiving surface 12a is represented as XG12, distance XG12=distance LG1−distance LX12, and therefore the distance XG12=21−10.005 =10.995 mm.

When the diameter of a blurred image G12 of the point 93B appearing on the light receiving surface 12a is represented as the blur diameter FD12, blur diameter FD12=(distance XG12/distance LX12)×optical system diameter LD1, and the blur diameter FD12=(10.995/10.005)×φ=1.099φ.

It is assumed that the optical system diameter LD1=φ=1.000 mm and the pixel pitch PP of the imaging element 12=1.2 μm. Then, when the depth JL11 of the subject=10000 mm, the blur diameter FD11=1.098=1.098 mm˜915 pixels. On the other hand, when the depth JL12 of the subject=20000 mm, the blur diameter FD12=1.099φ=1.099 mm˜915 pixels.

That is, when the depth of the subject 93 is 10000 mm and 20000 mm, the number of pixels corresponding to the blur diameter appearing on the light receiving surface 12a of the imaging element 12 remains the same, and the difference in the depth is not reflected in the number of pixels. In other words, it is difficult to distinguish between the depths of the subject at 10000 mm and 20000 mm. Therefore, it is understood that the estimation accuracy of the depth of a distant object using the imaging system of wide-angle type is low.

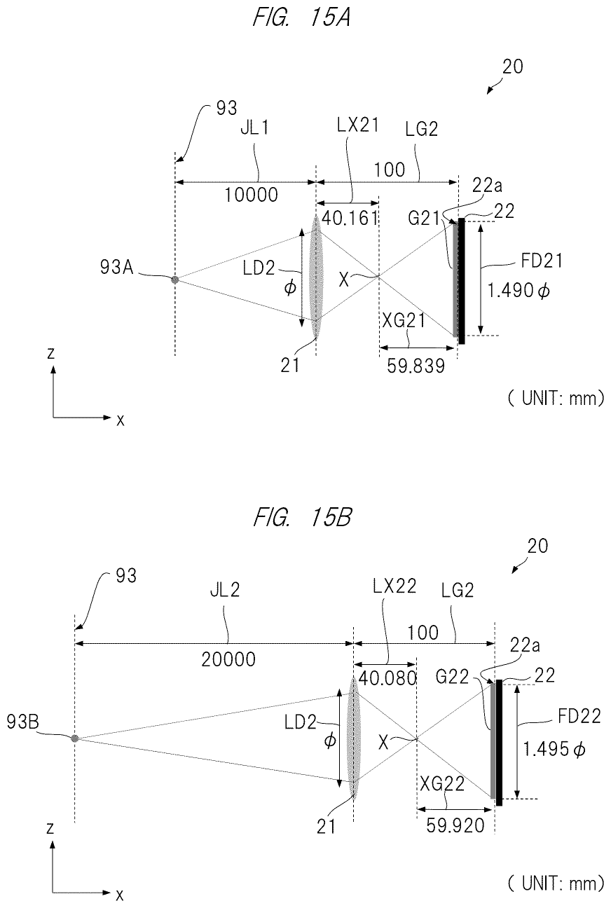

Next, estimation accuracy of a depth of an object using an imaging system of telephoto type with a narrow angle of view will be described. FIG. 15A is a diagram illustrating the spread of blur in an image when a close object is imaged by the imaging system of telephoto type. FIG. 15B is a diagram illustrating the spread of blur in an image when a distant object is imaged by the imaging system of telephoto type. In FIGS. 15A and 15B, a direction of the main axis of the optical system is an x direction, and a direction perpendicular to the x direction is a y direction.

As illustrated in FIGS. 15A and 15B, a telephoto imaging system 20, which is an imaging system of telephoto type, includes a telephoto optical system 21, which is an optical system of telephoto type, and an imaging element 22, both of which are arranged with a gap in the x direction. Here, assuming that, in the telephoto optical system 21, the focal length f=40 mm and the focusing distance=66.7 mm, when the distance from the telephoto optical system 21 to the light receiving surface 22a of the imaging element 22 is represented as LG2, then the lens formula gives: 1/LG2+1/66.7˜1/40, and thus the distance LG2=100 mm. Also, when the diameter of the telephoto optical system 21 is represented as LD2, the optical system diameter LD2=φ.

First, as illustrated in FIG. 15A, it is assumed that the distance from the telephoto optical system 12 to a point 93A on the surface of a subject 93, that is, the depth JL1 of the subject 93=10000 mm. When the distance from the telephoto optical system 21 to the focal point X is represented as LX21, the lens formula gives: 1/LX21+1/10000˜1/40, and thus the distance LX21=40.161. When the distance from the focal point X to the light receiving surface 22a is represented as XG21, distance XG21=distance LG2−distance LX21, and therefore the distance XG21=100−40.161=59.839 mm.

When the diameter of a blurred image G21 of the point 93A appearing on the light receiving surface 22a is represented as a blur diameter FD21, blur diameter FD21=(distance XG21/distance LX21)×optical system diameter LD2, and therefore the blur diameter FD21=(59.839/40.161)×φ=1.490φ.

Next, as illustrated in FIG. 15B, it is assumed that the distance from the telephoto optical system 21 to a point 93B on the surface of the subject 93, that is, the depth JL2 of the subject 93=20000 mm. When the distance from the telephoto optical system 21 to the focal point X is represented as LX22, the lens formula gives: 1/LX22+1/20000˜1/10, and thus the distance LX22=40.080. When the distance from the focal point X to the light receiving surface 22a is represented as XG22, distance XG22=distance LG2−distance LX22, and therefore the distance XG22=100−40.080=59.920 mm.

When the diameter of a blurred image G22 of the point 93B appearing on the light receiving surface 22a is represented as a blur diameter FD22, diameter blur FD22=(distance XG22/distance LX22)×optical system diameter LD2, and the blur diameter FD22=(59.920/40.080)×φ=1.495φ.

It is assumed that the optical system diameter LD2=φ=1.000 mm and the pixel pitch PP of the imaging element 22=1.2 μm. Then, when the depth JL1 of the subject=10000 mm, the blur diameter FD21=1.490φ=1.490 mm˜1241 pixels. Meanwhile, when the depth JL2 of the subject=20000 mm, the blur diameter FD22=1.495φ=1.495 mm˜1245 pixels.

That is, when the depth of the subject 93 is 10000 mm and 20000 mm, the difference in the number of pixels corresponding to the blur diameter appearing on the light receiving surface 22a of the imaging element 22 becomes 4 pixels, and the difference in the depth is reflected in the number of pixels. In other words, it is possible to distinguish between the depths of the subject at 10000 mm and 20000 mm. Therefore, it is understood that the estimation accuracy of the depth of a distant object using the imaging system of telephoto type is high.

As a result of the above considerations and examination, the present inventors have devised the present disclosure. Each embodiment of the present disclosure will be described below. Each embodiment described below is an example for implementing the present disclosure and does not limit the technical scope of the present disclosure. In addition, in each following embodiment, components having the same functions are denoted by the same reference numerals, and repeated explanations thereof will be omitted unless particularly necessary.

### First Embodiment

### <Overview of Imaging Device According to First Embodiment>

An imaging device according to the first embodiment of the present application will be described below. An imaging device according to the first embodiment of the present application is an imaging device including a first imaging system having a first angle of view, a second imaging system having a second angle of view that is narrower than the first angle of view, and an arithmetic control unit connected to the first imaging system and the second imaging system, in which the arithmetic control unit performs first imaging processing of coded imaging a subject using the first imaging system to obtain a first imaged image, detection processing of detecting a specific object that is included in the subject and is positioned at a distance from the first imaging system equal to or greater than a threshold based on the obtained first imaged image, second imaging processing of coded imaging the detected specific object using the second imaging system to obtain a second imaged image, first decoding processing of decoding the first imaged image to obtain first depth information representing a depth of an object at each position of the subject, and second decoding processing of decoding the second imaged image to obtain second depth information representing a depth of the specific object.

An imaging device according to the first embodiment of the present application may also be an imaging device including a first imaging system having a first angle of view, a second imaging system having a second angle of view that is narrower than the first angle of view, and an arithmetic control unit connected to the first imaging system and the second imaging system, in which the arithmetic control unit performs first imaging processing of coded imaging a subject using the first imaging system to obtain a first imaged image, first decoding processing of decoding the first imaged image to obtain a first decoded image representing the subject and first depth information representing a depth of an object at each position of the subject, detection processing of detecting a specific object that is included in the subject and is positioned at a distance from the first imaging system equal to or greater than a threshold based on the first decoded image, second imaging processing of coded imaging the detected specific object using the second imaging system to obtain a second imaged image, and second decoding processing of decoding the second imaged image to obtain second depth information representing a depth of the specific object.

In other words, the imaging device according to the first embodiment is characterized in that an imaged image by an imaging system of wide-angle type is used to estimate the depth of the entire subject, and an imaged image by an imaging system of telephoto type is used to estimate the depth of a distant specific object of interest.

### <Installation and Configuration Examples of Imaging Device>

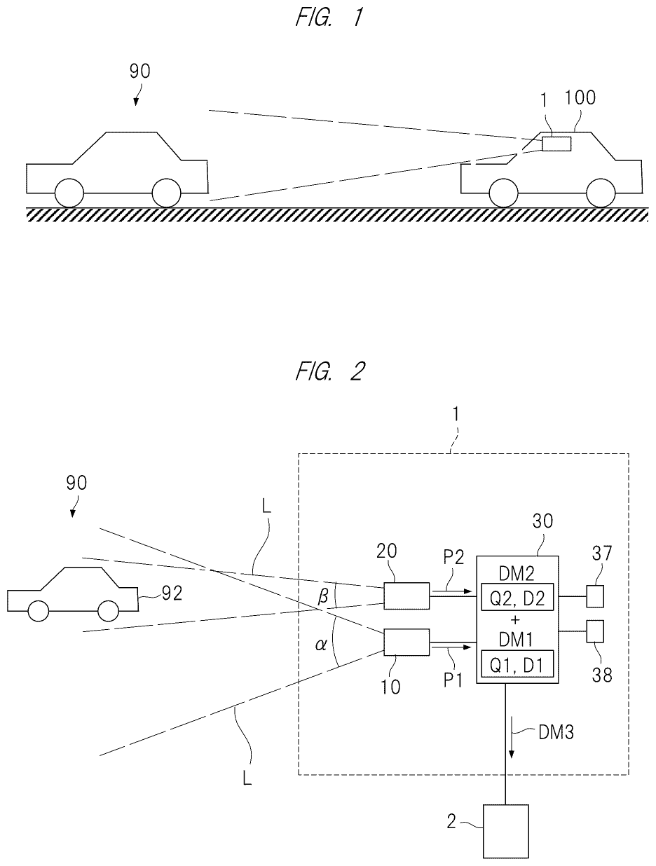

FIG. 1 is a diagram illustrating an installation example of the imaging device according to the first embodiment. In the first embodiment, an imaging device 1 is installed in an automobile 100, as illustrated in FIG. 1. The imaging device 1 is configured to image a subject 90 in front of the automobile 100. The subject 90 includes a front car traveling in front of the automobile 100.

FIG. 2 is a diagram illustrating a configuration example of the imaging device 1. As illustrated in FIG. 2, the imaging device 1 includes a standard imaging system 10, a telephoto imaging system 20, an arithmetic control unit 30, an operation unit 37, and a display unit 38. The standard imaging system 10, the telephoto imaging system 20, the operation unit 37, and the display unit 38 are each connected to the arithmetic control unit 30.

The standard imaging system 10 is an example of the “first imaging system” in the present application. The telephoto imaging system 20 is an example of the “second imaging system” in the present application. The arithmetic control unit 30 is an example of the “arithmetic control unit” in the present application.

The standard imaging system 10 is an imaging system of wide-angle type having a first angle of view α. The configuration of the standard imaging system 10 will be described.

FIG. 3 is a diagram illustrating a configuration example of the standard imaging system 10. As illustrated in FIG. 3, the standard imaging system 10 includes a standard optical system 11, an imaging element 12, and a mask M1.

The standard optical system 11 is, for example, a wide-angle lens with a relatively wide angle of view. The standard optical system collects light L arriving from a subject 90 and forms an image on the light receiving surface 12a of the imaging element 12.

The mask M1 is an optical filter that transmits a portion of the light L entering the standard optical system 11 and shields the other portion of the light L. The mask M1 is disposed in a light entry region where the light L enters the standard optical system 11 from the subject 90. The mask M1 is disposed, for example, on the subject 90 side of the standard optical system 11. The mask M1 may be disposed in the standard optical system 11. The “mask” is also referred to as “coded aperture”, “coded stop”, or “aperture”.

The imaging element 12 is an electronic component that performs photoelectric conversion, and has a multitude of photoelectric conversion elements arranged two-dimensionally. The multitude of photoelectric conversion elements form the light receiving surface 12a. The imaging element 12 photoelectrically converts the brightness and darkness of light of the image formed on the light receiving surface 12a into an amount of electric charge. The imaging element 12 outputs data of a standard imaged image P1 representing the subject 90 when imaging is performed by instantaneously capturing an electric signal obtained by photoelectric conversion. The imaging is performed, for example, by a rolling shutter method or a global shutter method. The standard imaged image Pl is an example of the “first imaged image” in the present application.

The “imaging element” is also referred to an “image sensor”. The imaging element 12 is, for example, a Charge Coupled Device (CCD) image sensor, a Complementary Metal Oxide Semiconductor (COMS) image sensor, or the like.

The light L arriving from a point image h1 on a surface 90a of the subject 90 passes through the mask M1, is encoded by a point spread function f1, and enters the standard optical system 11. The light L that passes through the standard optical system 11 forms a blurred image on the light receiving surface 12a of the imaging element 12. The blurred image is an image encoded with the point spread function f1 that is specific to the standard imaging system 10 that includes the mask M1.

The telephoto imaging system 20 is an imaging system of telephoto type having a second angle of view β that is narrower than the first angle of view α. The configuration of the telephoto imaging system 20 will be described.

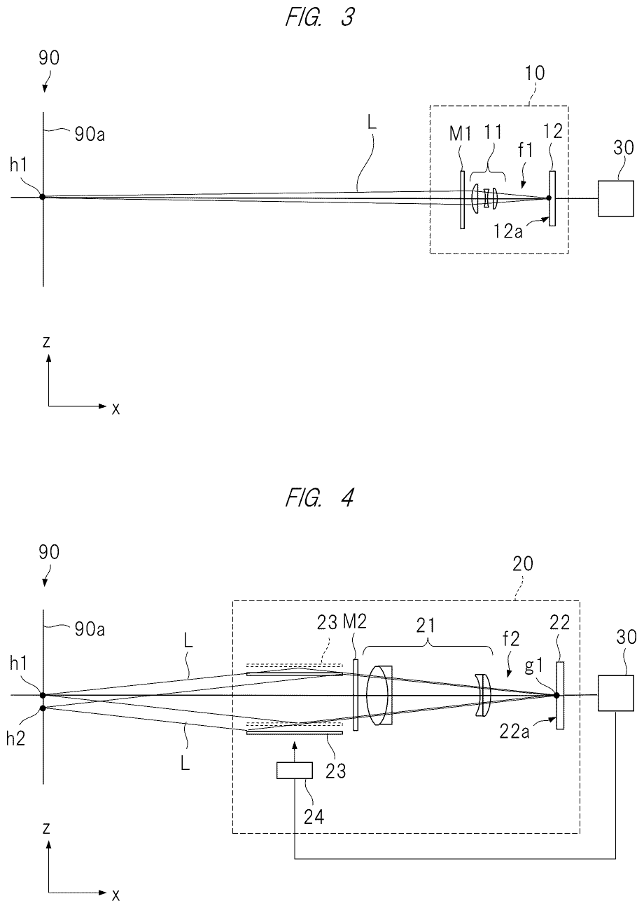

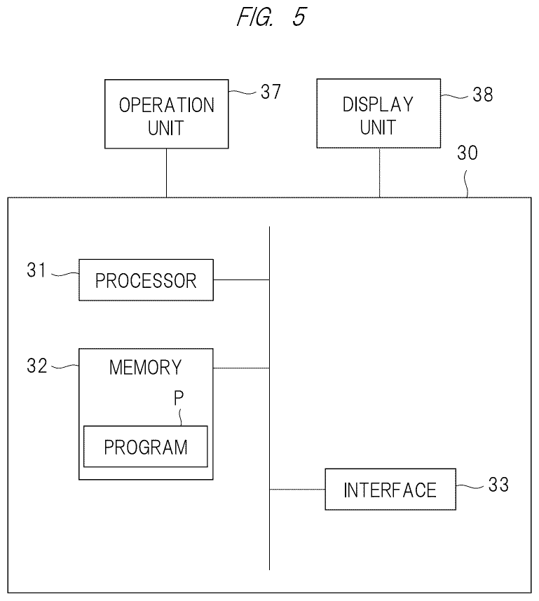

FIG. 4 is a diagram illustrating a configuration example of the telephoto imaging system 20. As illustrated in FIG. 4, the telephoto imaging system 20 includes a telephoto optical system 21, an imaging element 22, a mask M2, a light reflecting cylinder 23, and an imaging direction changing unit 24. The light reflecting cylinder 23 is an example of a “reflecting unit” in the present application. Also, the imaging direction changing unit 24 is an example of a “changing unit” in the present application.

The telephoto optical system 21 is, for example, a telephoto lens with a relatively narrow angle of view. The telephoto optical system 21 collects the light L arriving from a specific object of the subject 90, located ahead in an imaging direction, and forms an image on the light receiving surface 22a of the imaging element 22. The telephoto optical system 21 may be an optical zoom lens, or the standard imaging system 10 may be provided with an optical zoom function and used as the telephoto imaging system 20.

The mask M2 has the same configuration and function as the mask M1, and serves as an optical filter for the light L entering the telephoto optical system 21. The mask M2 is disposed in the light entry region where the light L enters the telephoto optical system 21 from the subject 90. The mask M2 is disposed, for example, on the subject 90 side of the telephoto optical system 21. The mask M2 may be disposed in the telephoto optical system 21.

The imaging element 22 has the same configuration and function as the imaging element 12, and outputs data of a telephoto imaged image P2 represented by an image formed on the light receiving surface 22a when imaging is performed. The telephoto imaged image P2 is an example of the “second imaged image” in the present application.

The light reflecting cylinder 23 is a cylindrical member having a light reflecting surface formed on the inside thereof. The light reflecting cylinder 23 is disposed on the subject side of the telephoto optical system 21 and is configured to move by a small distance in the direction perpendicular to the x direction which is the main axis direction of the telephoto optical system 21. The cross section of the light reflecting cylinder 23 taken along a direction perpendicular to the x direction has, for example, a circular or rectangular shape. The light reflecting cylinder 23 is an example of a “reflecting unit” in the present application.

The reference position of the light reflecting cylinder 23 is the position where the central axis of the light reflecting cylinder 23 and the main axis of the telephoto optical system 21 overlap. When the light reflecting cylinder 23 is positioned at the reference position, the light L arriving from the point image h1 on the surface 90a of the subject 90 is reflected by the reflecting surface inside the light reflecting cylinder 23 and enters the telephoto optical system 21 through the mask M2. The light L having passed through the telephoto optical system 21 forms a blurred image at a position g1 on the light receiving surface 22a of the imaging element 22. The blurred image is an image encoded with a point spread function f2 that is specific to the telephoto imaging system 20 that includes the mask M2.

On the other hand, when the light reflecting cylinder 23 is positioned at a position misaligned from the reference position, the light L, which is arriving from a point image h2 positioned at a different position from the point image h1 on the surface 90a of the subject 90, is reflected by the reflecting surface inside the light reflecting cylinder 23, encoded through the mask M2, and enters the telephoto optical system 21. The light L having passed through the telephoto optical system 21 forms a blurred image at the position g1 on the light receiving surface 22a of the imaging element 22.

As described above, when the position of the light reflecting cylinder 23 with respect to the telephoto optical system 21 changes in the direction perpendicular to the x direction, the imaging direction of the telephoto imaging system 20 changes. That is, by controlling the position of the light reflecting cylinder 23, the imaging direction of the telephoto imaging system 20 can be controlled.

The imaging direction changing unit 24 changes the position of the light reflecting cylinder 23 with respect to the telephoto optical system 21 in the direction perpendicular to the x direction. The imaging direction changing unit 24 is connected to the arithmetic control unit 30. The imaging direction changing unit 24 controls the imaging direction of the telephoto imaging system 20 by moving the light reflecting cylinder 23 and changing the position of the light reflecting cylinder 23 based on a control signal transmitted from the arithmetic control unit 30. Also, the imaging direction changing unit 24 is an example of a “changing unit” in the present application.

The imaging direction changing unit 24 moves the light reflecting cylinder 23 by a mechanism using a motor, an electrostatic actuator, or the like as a drive source. The imaging direction changing unit 24 may be configured, for example, with a Micro Electro Mechanical System (MEMS), or the like. The imaging direction changing unit 24 may change the imaging direction of the telephoto imaging system 20 by moving a part or the whole of the telephoto optical system 21.

The configuration of the arithmetic control unit 30 will be described. FIG. 5 is a diagram illustrating a configuration example of the arithmetic control unit 30. The arithmetic control unit 30 is, for example, a computer, and includes a processor 31, a memory 32, and an interface 33 as illustrated in FIG. 5.

The processor 31 is, for example, a Central Processing Unit (CPU), a Micro-Processing Unit (MPU), a microcontroller, a Graphics Processing Unit (GPU), or the like.

The memory 32 is, for example, a semiconductor storage device, and may include a magnetic disk, an optical disk, and the like. The memory 32 stores a program P, and the processor 31 reads and executes the program P to perform various processing.

The interface 33 is connected to the imaging elements 12 and 22, the imaging direction changing unit 24, the processor 31, an external device 2, and the like, and mediates the transmission and reception of signals or data between these devices.

In addition, when the arithmetic control unit 30 is a computer, all or part of the computer may be composed of semiconductor circuits such as a Digital Signal Processor (DSP), an Application Specific Integrated Circuit (ASIC), a Field Programmable Gate Array (FPGA), or a Complex Programmable Logic Device (CPLD). The arithmetic control unit 30 may also include electronic circuits such as an image processing engine that processes data output from the imaging elements 12 and 22.

### <Various Processing Performed by Arithmetic Control Unit>

Here, the various processing performed by the arithmetic control unit 30 will be described.

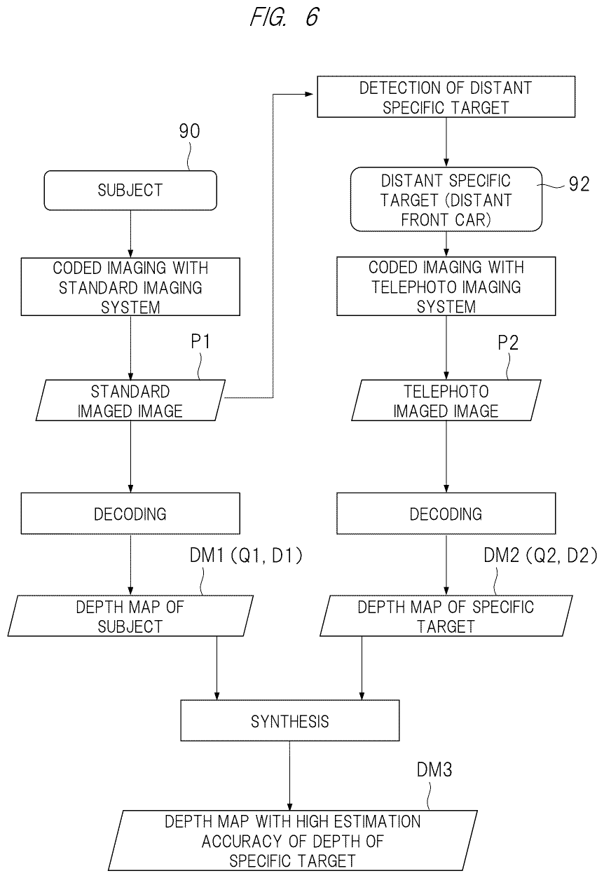

FIG. 6 is a schematic diagram illustrating various processing performed by the arithmetic control unit. As illustrated in FIG. 6, the arithmetic control unit 30 coded images the subject 90 using the standard imaging system 10 of wide-angle type, and obtains the standard imaged image P1 that is an imaged image representing the subject 90 from the standard imaging system 10. The arithmetic control unit 30 detects a distant front car 92 as a distant specific object included in the subject 90, based on the obtained standard imaged image P1. The arithmetic control unit 30 controls the imaging direction of the telephoto imaging system 20 so that the detected distant front car 92 can be coded imaged using the telephoto imaging system 20. The arithmetic control unit 30 then uses the telephoto imaging system 20 to coded image the distant front car 92, and obtains a telephoto imaged image P2 which is an imaged image representing the detected distant front car 92 from the telephoto imaging system 20.

The arithmetic control unit 30 decodes the obtained standard imaged image P1 to obtain a standard decoded image Q1 representing the subject 90 with reduced blur, and standard depth information D1 representing the depth of the object corresponding to each position of the subject 90 represented by the standard decoded image Q1. In addition, the arithmetic control unit 30 decodes the obtained telephoto imaged image P2 to obtain a telephoto decoded image Q2 representing the distant front car 92 with reduced blur, and telephoto depth information D2 representing the depth of the object corresponding to each position of the distant front car 92 represented by the telephoto decoded image Q2. The standard decoded image Q1 is an example of the “first decoded image” in the present application. The telephoto decoded image Q2 is an example of a “second decoded image” in the present application.

The arithmetic control unit 30 generates a standard depth map DM1 by associating each position of the standard decoded image Q1 with the depth of each position of the subject 90 represented by the standard depth information D1. Further, the arithmetic control unit 30 generates a telephoto depth map DM2 by associating each position of the telephoto decoded image Q2 with the depth of each position of the front car 92 represented by the telephoto depth information D2. Then, the arithmetic control unit 30 superimposes the telephoto depth map DM2 on the standard depth map DM1 to combine the two depth maps, thereby generating a depth map DM3.

The standard depth map DM1 is an example of a “first depth map” in the present application. Also, the telephoto depth map DM2 is an example of a “second depth map” in the present application. The processing of generating the standard depth map DM1 is an example of “first generation processing” in the present application. Also, the processing of generating the telephoto depth map DM2 is an example of “second generation processing” in the present application.

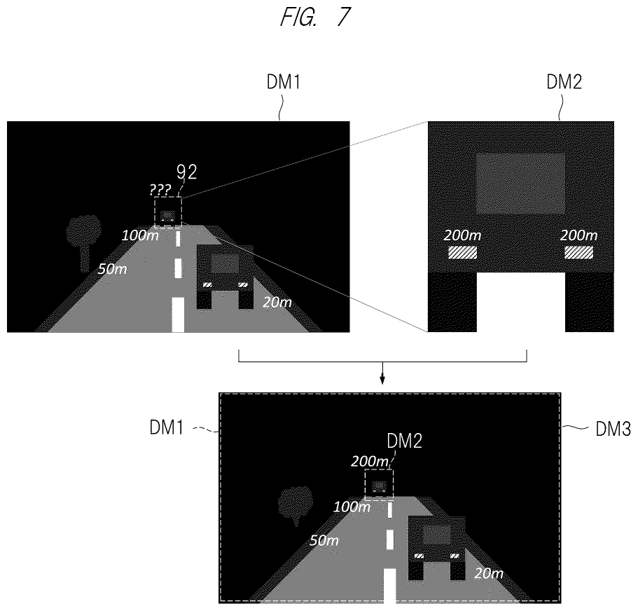

FIG. 7 is a diagram illustrating how the depth map DM3 is generated. As illustrated in FIG. 7, the depth map DM3 is generated by superimposing the telephoto depth map DM2 on the standard depth map DM1. The depth map DM3 uses the telephoto depth information D2 with high estimation accuracy of depth for the image portion of the distant front car 92, therefore; the depth map DM is a depth map that accurately reflects the depth of the distant front car 92. The front car 92 is an example of a “front vehicle” in the present application.

The arithmetic control unit 30 may generate the depth map DM3 based on the standard decoded image Q1 and the standard depth information D1, or the standard depth map DM1 and the telephoto depth information D2. In this case, the depth map DM3 is a depth map in which, in the standard decoded image Q1 representing the subject 90, the image portion representing the distant front car 92 is associated with a depth based on the telephoto depth information D2, and the other image portion is associated with the depth based on the standard depth information D1.

The arithmetic control unit 30 outputs the generated depth map DM3 to the external device 2 connected to the imaging device 1. The external device 2 is, for example, a driving assistance device, and performs driving assistance for the automobile 100 using the depth map DM3.

The arithmetic control unit 30 receives commands and information input based on the operation of the operation unit 37 by a user. Also, the arithmetic control unit 30 causes the display unit 38 to display information intended for the user. The operation unit 37 may be, for example, keys, buttons, dials, or the like. The display unit 38 may be, for example, a liquid crystal panel, an organic EL panel, or the like. The operation unit 37 and the display unit 38 may be integrally configured, and may be, for example, a touch panel.

In addition, when detecting an image representing a distant specific object in an image representing the subject 90, such as a standard imaged image, the arithmetic control unit 30 uses a known detection method, such as template matching or an image detection method using artificial intelligence (AI).

Whether or not a specific object is present at a distance, that is, whether or not the distance from the standard imaging system 10 to the specific object is equal to or greater than a threshold, is recognized based on, for example, the size or the number of pixels of an image representing the specific object. For example, when it is determined that the ratio of the size of an image representing the specific object to the size of the standard imaged image P1 is equal to or smaller than a preset first threshold, the specific object is recognized as being distant. Also, for example, when it is determined that the number of pixels constituting an image representing the specific object is equal to or less than a preset second threshold, the specific object is recognized as being distant.

Alternatively, whether the specific object is present at a distance is determined based on the standard depth map DM1.

The arithmetic control unit 30 is set to store the features of the specific object so that an image representing the specific object present at a distance can be detected in the image representing the subject 90. In the first embodiment, the specific object to be detected is an automobile traveling ahead, that is, a front car. In this case, for example, the user inputs and stores, as one of the features of the automobile traveling ahead, that is, a feature of the two taillights provided at the rear of the automobile being arranged with a space therebetween in the horizontal direction, in the arithmetic control unit 30.

### <Processing Flow in Imaging Device>

A flow of processing in the imaging device according to the first embodiment will be described below.

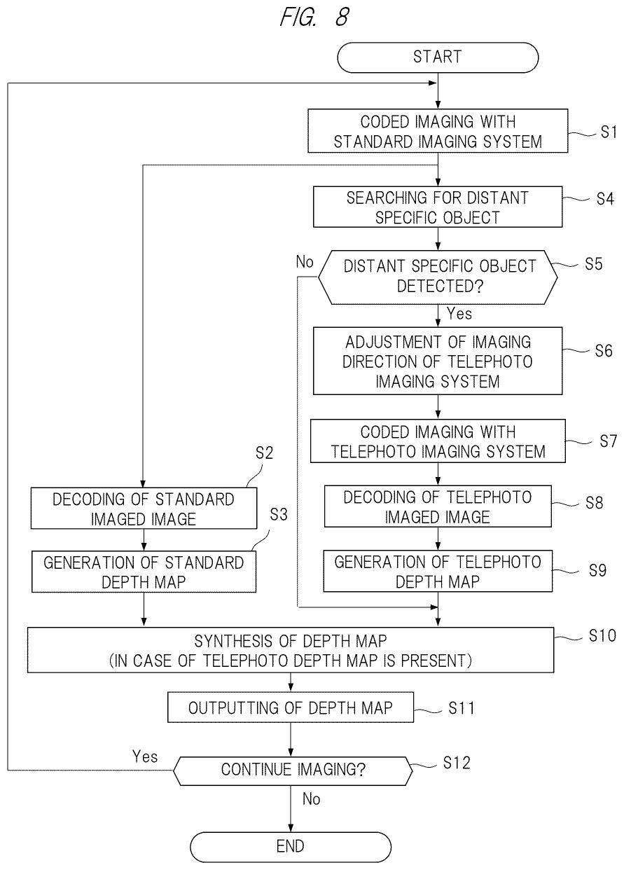

FIG. 8 is a flowchart illustrating an example of processing in the imaging device according to the first embodiment. As illustrated in FIG. 8, in Step S1, coded imaging is performed by the standard imaging system. Specifically, the arithmetic control unit 30 performs a first coded imaging processing in which the subject 90 is coded imaged using the standard imaging system 10 to obtain a standard imaged image P1.

After processing of Step S1 is performed, processing of Steps S2 to S3 and processing of Steps S4 to S9 are performed. However, the processing of Steps S2 to S3 and the processing of Steps S4 to S9 may be performed in parallel, or sequentially according to a predetermined priority.

In S2, the Step standard imaged image is decoded. Specifically, the arithmetic control unit 30 performs first decoding processing in which the standard imaged image P1 is decoded by deconvolution based on the point spread function f1. Through this decoding, the arithmetic control unit 30 obtains the standard decoded image Q1 with reduced blur of the subject 90 and the standard depth information D1 representing an estimated value of depth of object at each position of the subject 90 represented by the standard decoded image Q1.

In Step S3, standard depth map is generated. Specifically, the arithmetic control unit 30 performs first depth map generation processing in which the standard depth map DM1 is generated by associating each position of the standard decoded image Q1 with the estimated value of depth of object at each position of the subject 90 represented by the standard depth information D1.

Meanwhile, in Step S4, a search is performed for a distant specific object. Specifically, the arithmetic control unit 30 performs specific object searching processing of searching for a distant front car 92 as a distant specific object in the standard imaged image P1.

In Step S5, a determination is made as to whether or not the distant specific object has been detected. Specifically, the arithmetic control unit 30 performs search and determination processing to determine whether or not a distant front car 92 has been detected as a distant specific object. When it is determined that the front car 92 has been detected (S5: Yes), the arithmetic control unit 30 advances the processing step to Step S6. Meanwhile, when it is determined that the front car 92 has not been detected (S5: No), the arithmetic control unit 30 advances the processing step to Step S10.

In Step S6, the imaging direction of the telephoto imaging system is adjusted. Specifically, the arithmetic control unit 30 performs imaging direction control processing to control the imaging direction changing unit 24 to adjust the imaging direction of the telephoto imaging system 20 so that the detected front car 92 can be imaged using the telephoto imaging system 20.

In Step S7, coded imaging is performed using the telephoto imaged image. Specifically, the arithmetic control unit 30 performs second coded imaging processing in which the detected front car 92 is coded imaged using the telephoto imaging system 20 to obtain a telephoto imaged image P2.

In Step S8, the telephoto imaged image is decoded. Specifically, the arithmetic control unit 30 performs second decoding processing in which the telephoto imaged image P2 is decoded by deconvolution based on the point spread function f2. Through this decoding, the arithmetic control unit 30 obtains a telephoto decoded image Q2 with reduced blur of the front car 92, and telephoto depth information D2 representing an estimated value of depth of object at each position of the front car 92 represented by the telephoto decoded image Q2.

In Step S9, the telephoto depth map is generated. Specifically, the arithmetic control unit 30 performs second depth map generation processing in which the telephoto depth map DM2 is generated by associating each position of the telephoto decoded image Q2 with the estimated value of depth of object at each position of the front car 92 represented by the telephoto depth information D2.

In Step S10, when the processing in both Steps S3 and S9 have been performed, synthesis of the depth maps is performed. Specifically, the arithmetic control unit 30 performs third depth map generation processing in which the telephoto depth map DM2 obtained in Step S9 is superimposed on the standard depth map DM1 obtained in Step S3 to generate the depth map DM3. On the other hand, when only the processing of Step S3 out of Steps S3 and S9 is performed, the standard depth map DM1 obtained in Step S3 becomes the depth map DM3. Specifically, the arithmetic control unit 30 sets the standard depth map DM1 as the depth map DM3.

In Step S11, the depth map is output. Specifically, the arithmetic control unit 30 performs output processing in which the depth map DM3 is output to the external device 2.

In Step S12, a determination is made as to whether or not to continue imaging. Specifically, the arithmetic control unit 30 performs continuation determination processing to determine whether or not to continue imaging based on whether an imaging stop command has been input, whether an error has occurred, and the like. When it is determined that imaging is to continue (S12: Yes), the arithmetic control unit 30 returns the processing step to Step S1, and imaging is continued. On the other hand, when it is determined that imaging is not to continue (S12: No), the arithmetic control unit 30 ends imaging.

### <First Modification>

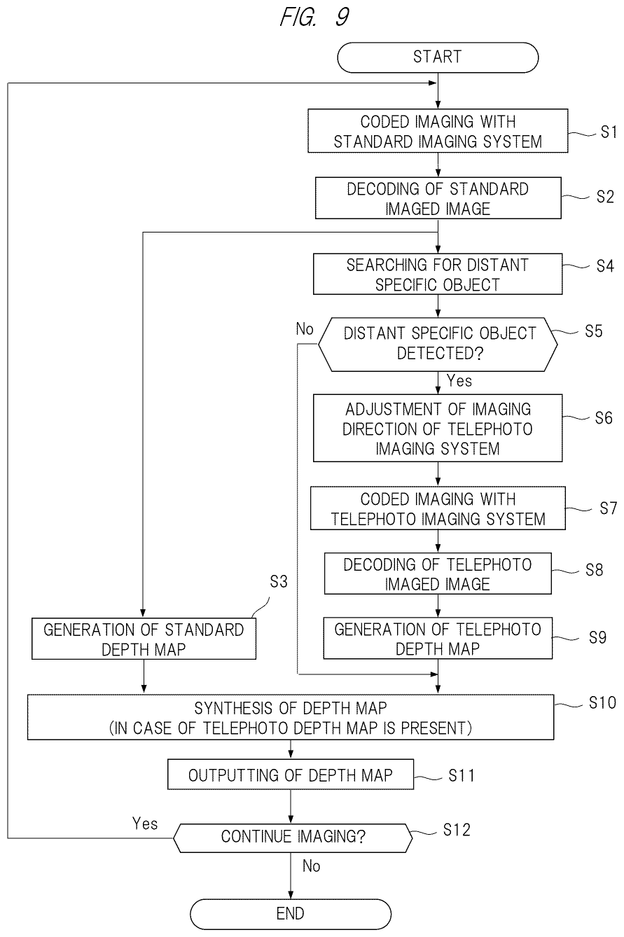

FIG. 9 is a flowchart illustrating a modification of processing in the imaging device according to the first embodiment. As a modification of the processing in the imaging device according to the first embodiment, as illustrated in FIG. 9, after Steps S1 and S2 are performed, Step S3 and Steps S4 to S9 may be performed. In this case, the search for the distant specific object in Step S4 is performed based on the decoded image P3 obtained by decoding the standard imaged image P1 in Step S2. The other Steps are the same as those in the flowchart illustrated in FIG. 8, and therefore the description thereof is omitted here.

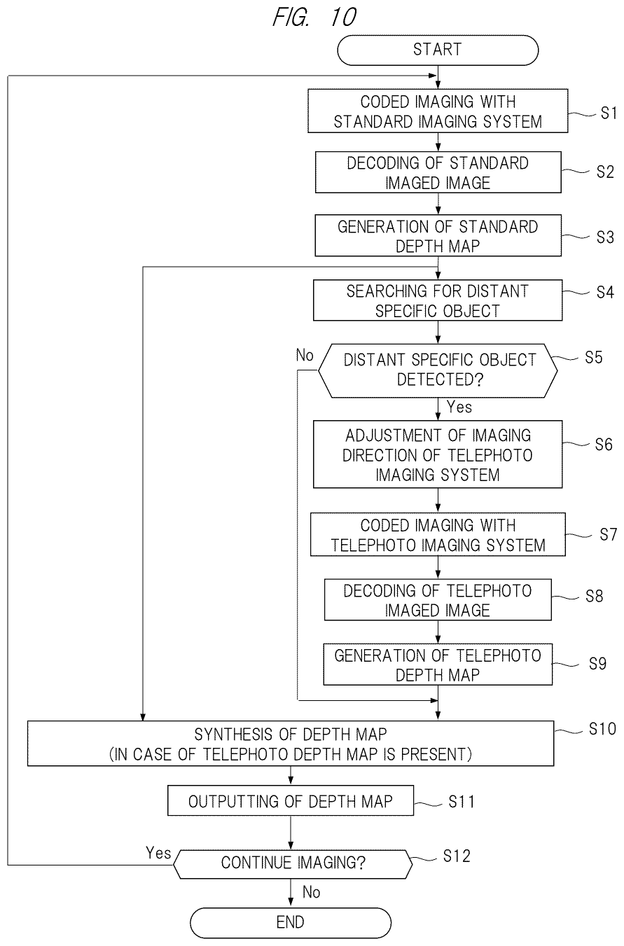

Also, as illustrated in FIG. 10, it may be determined whether or not a specific object is present at a distance based on the standard depth map DM1.

As described above, according to the first embodiment, a more practical DFD technique can be provided. More specifically, according to the imaging device 1, the entire subject is coded imaged using the standard imaging system with a wide angle of view, and a distant specific object within the subject is coded imaged using the telephoto imaging system with a narrow angle of view. In coded imaging using the telephoto imaging system with a narrow angle of view, deterioration in the estimation accuracy of depth is suppressed. Such coded imaging can improve the estimation accuracy of depth of a distant object, the estimation accuracy of which tends to decrease. In other words, it is possible to generate a depth map in which the estimation accuracy of depth for a distant object of interest within the subject does not deteriorate. As a result, it is possible to further improve the practicality of the depth estimation technique using DFD.

### <Second Modification>

Each of the masks M1 and M2 may be a combination of a plurality of masks. For example, the mask M1 may include a mask M11 and a mask M12 having aperture geometric patterns different from each other, and the mask M2 may include a mask M21 and a mask M22 having aperture geometric patterns different from each other. In this case, the first coded imaging processing using the standard imaging system 10 includes coded imaging using the mask M11 and coded imaging using the mask M12. Also, the second coded imaging processing using the telephoto imaging system 20 includes coded imaging using the mask M21 and coded imaging using the mask M22.

The first decoding processing includes decoding by deconvolution of a plurality of imaged images obtained by the first coded imaging based on the point spread function specific to each of the masks M11 and M12. Also, the second decoding processing includes decoding by deconvolution of a plurality of imaged images obtained by the second coded imaging based on the point spread function specific to each of the masks M21 and M22. The depth map DM3 of the object is obtained by combining the first depth map obtained by the first decoding processing and the second depth map obtained by the second decoding processing.

The masks M11, M12 and the masks M21, M22 are each implemented by, for example, a liquid crystal optical shutter. Forming individual masks or setting a maskless state can be implemented through the on/off control of each segment of the liquid crystal in the liquid crystal optical shutter.

FIG. 11 is an example illustrating a liquid crystal optical shutter implementing a plurality of masks. As illustrated in FIG. 11, a liquid crystal shutter LS includes a light-shielding unit BM and segments R1 to R3 that can select between a light-shielding state (On state in the case of normally white, Off state in the case of normally black) and a light-transmitting state (Off state in the case of normally white, On state in the case of normally black). The light-shielding unit BM is disposed on the outer periphery of a light entry region R of light entering the optical system. The combined region of the segments R1 to R3 corresponds to the light entry region R. For example, the segment R1 corresponds to a circular region positioned at the upper right of the light entry region, the segment R2 corresponds to a circular region positioned at the lower left of the light entry region, and the segment R3 corresponds to a region obtained by removing segments R1 and R2 from the light entry region R.

The segments R1 to R3 are controlled to be turned on and off based on the input signals to the corresponding electrodes. By turning off the segment R1 and turning on the segments R2 and R3, the mask M11 or the mask M12 can be implemented, in which the circular region corresponding to the segment R1 becomes an aperture. Also, by turning off the segment R2 and turning on the segments R1 and R3, the mask M21 or the mask M22 can be implemented, in which the circular region corresponding to the segment R2 becomes an aperture. The maskless state can be implemented by turning off all of the segments R1 to R3.

Searching processing of searching for a specific object may be performed on the imaged image using the mask M11 or the imaged image using the mask M12, the decoded image obtained by the first decoding processing, or the imaged image in the maskless state.

### Second Embodiment

A method of estimating a subject depth according to the second embodiment of the present application will be described. A method of estimating a subject depth according to the second embodiment is a method of estimating a subject depth that includes coded imaging a subject using a first imaging system having a first angle of view to obtain a first imaged image, detecting a specific object that is included in the subject and is positioned at a distance from the first imaging system equal to or greater than a threshold based on the first imaged image, coded imaging the detected specific object using a second imaging system having a second angle of view that is narrower than the first angle of view to obtain a second imaged image, and decoding the first imaged image and the second imaged image to obtain depth information of the subject and depth information of the specific object.

A method of estimating a subject depth according to the second embodiment may also be a method of estimating a subject depth that includes coded imaging a subject using a first imaging system having a first angle of view to obtain a first imaged image, decoding the first imaged image to obtain a first decoded image representing the subject and depth information of the subject, detecting a specific object that is included in the subject and is positioned at a distance from the first imaging system equal to or greater than a threshold based on the first decoded image, coded imaging the detected specific object using a second imaging system having a second angle of view that is narrower than the first angle of view to obtain a second imaged image, and decoding the second imaged image to obtain depth information of the specific object.

According to the method of estimating a subject depth, a more practical DFD technique can be provided as in the first embodiment. More specifically, according to the present method of estimating a subject depth, it is possible to generate a depth map in which the estimation accuracy of depth for a distant object of interest within the subject does not deteriorate. As a result, it is possible to improve the practicality of the depth estimation technique using DFD.

### Third Embodiment

A program according to a third embodiment of the present disclosure will be described. A program according to the third embodiment is a program for causing a computer to execute processing to coded image a subject using a first imaging system having a first angle of view to obtain a first imaged image, processing to detect a specific object that is included in the subject and is positioned at a distance from the first imaging system equal to or greater than a threshold based on the first imaged image, processing to coded image the detected specific object using a second imaging system having a second angle of view that is narrower than the first angle of view to obtain a second imaged image, and processing to decode the first imaged image and the second imaged image to obtain depth information of the subject and depth information of the specific object.

A program according to the third embodiment may also be a program for causing a computer to execute processing to coded image a subject using a first imaging system having a first angle of view to obtain a first imaged image, processing to decode the first imaged image to obtain a first decoded image representing the subject and depth information of the subject, processing to detect a specific object that is included in the subject and is positioned at a distance from the first imaging system equal to or greater than a threshold based on the first decoded image, processing to coded image the detected specific object using a second imaging system having a second angle of view that is narrower than the first angle of view to obtain a second imaged image, and processing to decode the second imaged image to obtain depth information of the specific object.

Further, the present program may be a program for determining whether or not a specific object is present at a distance based on the standard depth map DM1.

The program may also be a program for causing a computer to function as the arithmetic control unit 30 included in the imaging device according to the first embodiment. Further, the program may also be a program for causing a computer to execute the method of estimating a subject depth according to the second embodiment.

It should be noted that a non-transitory tangible computer-readable recording medium in which the above program is recorded is also an embodiment of the present disclosure.

According to the program, a more practical DFD technique can be provided as in the first embodiment. More specifically, according to the present program, by having a computer execute the program, it is possible to generate a depth map in which the estimation accuracy of depth for a distant object of interest within the subject does not deteriorate. As a result, it is possible to improve the practicality of the depth estimation technique using DFD.

Although various embodiments of the present disclosure have been described above, the present disclosure is not limited to the above-described embodiments and includes various modifications. In addition, the above-described embodiments have been described in detail to clearly explain the present disclosure, and the present disclosure is not necessarily limited to having all of the configurations described. Furthermore, it is possible to replace part of the configuration of one embodiment with the configuration of another embodiment, and it is also possible to add the configuration of another embodiment to the configuration of one embodiment. All of these fall within the scope of the present invention. Furthermore, the numerical values and the like contained in the text and figures are merely examples, and the effects of the present disclosure will not be impaired even if different ones are used.

What is claimed is:

1. An imaging device comprising:
a first imaging system having a first angle of view; a second imaging system having a second angle of view that is narrower than the first angle of view; and
an arithmetic control unit connected to the first imaging system and the second imaging system,
wherein the arithmetic control unit performs
first imaging processing to coded image a subject using the first imaging system to obtain a first imaged image,
detection processing to detect a specific object that is included in the subject and is positioned at a distance from the first imaging system equal to or greater than a threshold based on the obtained first imaged image,
second imaging processing to coded image the detected specific object using the second imaging system to obtain a second imaged image,
first decoding processing to decode the first imaged image to obtain first depth information representing a depth of an object at each position of the subject, and
second decoding processing to decode the second imaged image to obtain second depth information representing a depth of the specific object.

2. The imaging device according to claim 1, further comprising
a changing unit that changes an imaging direction of the second imaging system,
wherein the arithmetic control unit controls the changing unit to perform imaging direction control processing of controlling the imaging direction so that the specific object is imaged by the second imaging system.

3. The imaging device according to claim 2,
wherein the second imaging system includes an optical system and a reflecting unit that reflects light from the subject and causes the light to enter the optical system, and
wherein the changing unit changes the imaging direction by moving the reflecting unit.

4. The imaging device according to claim 1,
wherein the arithmetic control unit
decodes the first imaged image, in the first decoding processing, to obtain a first decoded image representing the subject,
decodes the second imaged image, in the second decoding processing, to obtain a second decoded image representing the specific object,
performs first generation processing of generating a first depth map based on the first decoded image and the first depth information,
performs second generation processing of generating a second depth map based on the second decoded image and the second depth information, and
performs generation processing of generating a depth map of the subject by synthesizing the first depth map with the second depth map.

5. The imaging device according to claim 1,
wherein the arithmetic control unit
decodes the first imaged image, in the first decoding processing, to obtain a first decoded image representing the subject, and
performs generation processing of generating a depth map of the subject, based on the first decoded image, the first depth information, and the second depth information.

6. The imaging device according to claim 1,
wherein, in the detection processing, the arithmetic control unit detects the specific object by detecting an image representing the specific object in the first imaged image and having a size equal to or smaller than a first threshold.

7. The imaging device according to claim 1,
wherein the first imaging system and the second imaging system are installed in a vehicle, and
wherein, in the detection processing, the arithmetic control unit detects a front vehicle raveling in front of the vehicle as the specific object.

8. The imaging device according to claim 2,
wherein the first imaging system and the second imaging system are installed in a vehicle, and
wherein, in the e detection processing, the arithmetic control unit detects a front vehicle raveling in front of the vehicle as the specific object.

9. The imaging device according to claim 3,
wherein the first imaging system and the second imaging system are installed in a vehicle, and
wherein, in the detection processing, the arithmetic control unit detects a front vehicle raveling in front of the vehicle as the specific object.

10. The imaging device according to claim 4,
wherein the first imaging system and the second imaging system are installed in a vehicle, and
wherein, in the detection processing, the arithmetic control unit detects a front vehicle raveling in front of the vehicle as the specific object.

11. The imaging device according to claim 5,
wherein the first imaging system and the second imaging system are installed in a vehicle, and
wherein, in the detection processing, the arithmetic control unit detects a front vehicle raveling in front of the vehicle as the specific object.

12. The imaging device according to claim 6,
wherein the first imaging system and the second imaging system are installed in a vehicle, and
wherein, in the detection processing, the arithmetic control unit detects a front vehicle raveling in front of the vehicle as the specific object.

13. An imaging device comprising:
a first imaging system having a first angle of view; a second imaging system having a second angle of view that is narrower than the first angle of view; and an arithmetic control unit connected to the first imaging system and the second imaging system,
wherein the arithmetic control unit performs
first imaging processing to coded image a subject using the first imaging system to obtain a first imaged image,
first decoding processing to decode the first imaged image to obtain a first decoded image representing the subject and first depth information representing a depth of an object at each position of the subject,
detection processing to detect a specific object that is included in the subject and is positioned at a distance from the first imaging system equal to or greater than a threshold based on the first decoded image,
second imaging processing to coded image the detected specific object using the second imaging system to obtain a second imaged image, and
second decoding processing to decode the second imaged image to obtain second depth information representing a depth of the specific.
